(19) United States
(12) Patent Application Publication
(10) Pub. No.: US 2022/0339900 A1
(43) Pub. Date: Oct. 27, 2022

(54) MANUFACTURING A PACKAGING CONTAINER FROM FIBER-CONTAINING MATERIAL

(71) Applicant: MULTIVAC SEPP HAGGENMUELLER SE & CO. KG, Wolfertschwenden (DE)

(72) Inventor: Konrad MOESSNANG, Kempten (DE)

(73) Assignee: MULTIVAC SEPP HAGGENMUELLER SE & CO. KG, Wolfertschwenden (DE)

(21) Appl. No.: 17/730,503

(22) Filed: Apr. 27, 2022

(30) Foreign Application Priority Data
Apr. 27, 2021 (DE) 102021110679.6

(51) Int. Cl. B31B 50/59; B31B 50/74

(52) U.S. Cl. CPC B31B 50/592; B31B 50/741; B31B 2120/00

(57) ABSTRACT

In a method for manufacturing a packaging container, a web of material including a fiber-containing material is conveyed through a preforming station and through a forming station. In the preforming station, a forming region of the web of material is preformed by cooperation of a preforming die upper part with a preforming die lower part, the forming region being deformed between the preforming die upper part and the preforming die lower part during the preforming. In the forming station, a packaging depression is formed in the preformed forming region by cooperation of a forming die upper part with a forming die lower part, wherein the preformed forming region is deformed between the forming die upper part and the forming die lower part during forming.

### CROSS-REFERENCE TO RELATED APPLICATIONS

This application claims foreign priority benefits under 35 U.S.C. § 119(a)-(d) to German patent application number DE 10 2021 110 679.6, filed Apr. 27, 2021, which is incorporated by reference in its entirety.

### TECHNICAL FIELD

The present disclosure relates to the manufacturing of a packaging container. In particular, the disclosure relates to the manufacturing of a packaging container by forming a web of material.

### BACKGROUND

A wide variety of methods for manufacturing a packaging from thermoplastic foils are known from practice. For example, thermoforming packaging machines with a forming station are known, in which a packaging depression is formed in a thermoplastic plastic foil by thermoforming under the action of heat.

It has shown that methods known from the processing of thermoplastic foils cannot simply be transferred to the processing of webs of fiber-containing material, such as paper or cardboard. If fiber-containing material is to be mechanically formed, the material may easily be damaged, for example by tearing.

From DE 10 2012 201 882 A1, there is known an arrangement for thermoforming paper, cardboard or paperboard, wherein a blank of paper, cardboard or paperboard arranged between a punch and a die is formed by a relative movement between the punch and the die in a pressing direction. A micro-corrugation is provided on a circumferential surface of the punch. The micro-corrugation on the punch is intended to create micro-creases to prevent the formation of larger creases in the formed part.

### SUMMARY

It is an object of the disclosure to provide an improved way of manufacturing packaging containers from a web of material.

In accordance with an aspect of the disclosure, there is provided a method of manufacturing a packaging container. In the method, a web of material is conveyed through a preforming station and through a forming station. The web of material includes a fiber-containing material. In the preforming station, a forming region of the web of material is preformed by cooperation of a preforming die upper part with a preforming die lower part. During preforming, the forming region is deformed between the preforming die upper part and the preforming die lower part. In the forming station, a packaging depression is formed in the preformed forming region by cooperation of a forming die upper part with a forming die lower part. During forming, the preformed forming region is deformed between the forming die upper part and the forming die lower part.

For example, compared to packaging containers made of thermoplastic material, such as PET foils, packaging containers with a fiber-containing material may have improved environmental properties.

Preforming in the preforming station allows the forming region to be prepared for further forming in the forming station. If the forming region of the web of material has already been formed prior to forming the packaging depression, the likelihood of tearing of the web of material during forming in the forming station may be reduced. As a result of the preforming, the web of material may be pre-stretched to a certain extent in the forming region, which means that a higher degree of forming or transforming may be achieved during forming in the forming station. The two-stage process (preforming and forming) may enable the production of deeper packaging containers.

The fiber-containing material may be a material containing natural fiber. The use of a natural fiber-containing material may be advantageous, particularly from an ecological point of view, since it is at least partially a renewable raw material.

The fiber-containing material may be a paper material. For example, the paper material may include paper, cardboard or paperboard.

The paper material may have a composition including a long fiber content ranging from 10 to 80 percent by mass, preferably from 20 to 50 percent by mass, and including a short fiber content ranging from 20 to 90 percent by mass, preferably from 50 to 80 percent by mass. Long fiber is to be understood as a fiber having a fiber length of 2.6 to 4.4 mm, and short fiber is to be understood as a fiber having a fiber length of 0.7 to 2.2 mm.

The web of material may have a basis weight in the range of 20 to 300 g/m², or 20 to 120 g/m², or 40 to 100 g/m².

A fiber content of the web of material may include at least 70 percent by mass, or at least 75 percent by mass, or at least 80 percent by mass, or at least 85 percent by mass, or at least 90 percent by mass, or at least 95 percent by mass. The fiber content may be a natural fiber content.

The material of the web may be substantially non-thermoplastically deformable. Nevertheless, it is conceivable that the web of material includes components that are thermoplastically deformable on their own.

For example, the web of material may have a plastic content of at most 20 percent by mass, or at most 15 percent by mass, or at most 10 percent by mass, or at most 5 percent by mass. A plastic content may facilitate processing of the web of material. A plastic content may reduce the permeability of the web of material, for example for liquids or gases.

Preferably, a plurality of bulges of the web of material are created during the preforming in the forming region. For example, more than two bulges, or more than five bulges, or more than ten bulges, or more than twenty bulges, or more than thirty bulges may be created during the preforming in the forming region. By creating multiple bulges, the web of material may be efficiently pre-stretched in the forming region. In contrast to creating only one (larger) bulge, forming multiple (smaller) bulges may reduce the risk of breaking of the web. By creating a large number of bulges, the pre-stretching load acting on the web may be better distributed over the surface of the forming region than by creating a single bulge.

A bulge in the web of material may include a convex region of the web of material as viewed from a first two-dimensional side of the web of material. At least one concave region of the web of material, as viewed from the first two-dimensional side of the web of material, may be located between adjacent convex bulges of the web of material, as viewed from the first two-dimensional side of the web of material.

The web of material may be bulged in the forming region towards both two-dimensional sides of the web of material during preforming. The web of material may have one or more convex bulges on each side of the web of material, as viewed from both two-dimensional sides of the web of material.

During preforming, an undulating pattern may be formed in the forming region of the web of material. The undulating pattern may include an alternating sequence of convex and concave regions. Forming an undulating pattern allows the forming region of the web of material to be pre-stretched in an area. By creating an undulating pattern, a plurality of localized pre-stretching may be created in the forming region of the web of material. The undulating pattern may be a uniform undulating pattern or a spatially varying undulating pattern.

During the preforming, the web of material may be deformed to different degrees at different locations in the forming region. A degree of deformation and a distribution of deformation of the web of material during preforming may be adapted in view of the shape of the packaging container to be manufactured. Portions in which the material web must be strongly deformed to form the packaging depression may already be more strongly deformed during preforming than portions in which the material web must only be slightly deformed during forming of the packaging depression.

During preforming, a degree of deformation of the material web may be greatest in the portions that form one or more side walls of the packaging depression after forming. A degree of deformation of the web of material during preforming may be greater in regions that form one or more side walls of the packaging depression after forming than in regions that form a bottom of the packaging depression after forming.

During preforming, a degree of deformation of the web of material may be greatest in portions which, after forming, form a transition region between one or more side walls of the packaging depression and a bottom of the packaging depression. In the preforming, a degree of deformation of the web of material may be greater in portions that form a transition region between one or more side walls of the packaging depression and a bottom of the packaging depression after forming than in portions that form the one or more side walls or the bottom of the packaging depression.

During preforming, a portion of lesser deformation may be formed in the forming region of the web of material. The portion of lesser deformation may be framed by a portion of greater deformation. The portion of lower deformation may form a bottom of the packaging depression after the packaging depression has been formed. The portion of higher deformation may form one or more side walls of the packaging depression after the packaging depression has been formed. The portion of higher deformation may form a transition region between one or more side walls and a bottom of the packaging depression after the packaging depression has been formed.

The packaging depression may be in the shape of a bowl or cup. The packaging depression may have a depth of at least 1 cm, or of at least 2 cm, or of at least 3 cm, or of at least 5 cm, or of at least 7 cm. The packaging depression may have a flat bottom. The packaging depression may have one or more side walls extending from the flat bottom. For example, an angle between the flat bottom and the at least one sidewall may be in a range between 90 degrees and 135 degrees (measured inside the packaging depression).

The forming region of the web of material may be moistened and/or heated prior to preforming. The forming region of the web of material may be moistened and/or heated prior to forming the packaging depression. The forming region of the web of material may be moistened and/or heated between preforming and forming. Moistening and/or heating of the web of material may increase deformability of the web of material. Moistening and/or heating the web of material may reduce the likelihood of damage to the web of material during preforming and/or during forming.

According to another aspect of the disclosure, an apparatus for manufacturing a packaging container is provided. The apparatus includes a preforming station, a forming station, and a transport device. The preforming station includes a preforming die upper part and preforming die lower part. The forming station includes a forming die upper part and a forming die lower part. The transport device is configured to convey a web of material through the preforming station and through the forming station. The preforming die upper part and the preforming die lower part are configured to be moved relative to each other to deform a forming region of the web of material between each other, thereby preforming the forming region. The forming die upper part and the forming die lower part are configured to be moved relative to each other toward each other to deform the preformed forming region of the web of material between each other to form a packaging depression. The preforming die upper part and the preforming die lower part are configured to create a plurality of bulges in the forming region of the web of material during preforming.

The transport device may be configured to convey the web of material along a production direction. The preforming station may be arranged upstream of the forming station with respect to the production direction.

The apparatus for manufacturing a packaging container may include a machine frame. The preforming station and the forming station may be arranged or mounted on the machine frame, in particular one behind the other.

The apparatus may include a heating device. The heating device may be configured to heat the web of material. The heating device may be arranged upstream of the preforming station. The heating device may be arranged between the preforming station and the forming station. A first heating device may be provided, which is arranged upstream of the preforming station. A second heating device may be provided, which is arranged between the preforming station and the forming station.

The apparatus may include a moistening station for moistening the web of material. The moistening station may be located upstream of the preforming station. The moistening station may be arranged between the preforming station and the forming station. A first moistening station may be provided, which is arranged upstream of the preforming station. A second moistening station may be provided, which is arranged between the preforming station and the forming station.

The disclosure relates to a method for manufacturing a packaging container and to an apparatus for manufacturing a packaging container. Features or explanations described with respect to the method may be also applied to the apparatus. Features and explanations described with respect to the apparatus may be also applied to the method. The apparatus may be designed, suitable or configured to perform the method.

### BRIEF DESCRIPTION OF THE DRAWINGS

In the following, the disclosure is further explained with reference to an exemplary embodiment. In the Figures:

FIG. 1 is a schematic side view of an apparatus for manufacturing a packaging container according to an embodiment;

FIG. 2 is a schematic sectional view through the preforming station of the apparatus;

FIG. 3 is a schematic sectional view through the forming station of the apparatus; and

FIG. 4 is a schematic top view of the web of material after passing through the preforming station and before passing through the forming station.

### DETAILED DESCRIPTION

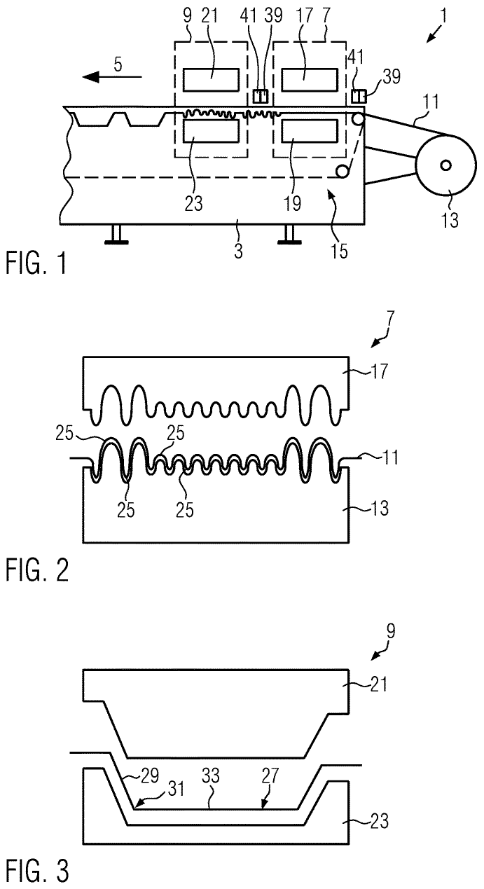

FIG. 1 shows a schematic representation of an apparatus 1 for manufacturing a packaging container according to an embodiment. The apparatus 1 includes a machine frame 3, on which a preforming station 7 and a forming station 9 are arranged one behind the other along a production direction 5.

Upstream of the preforming station 7 with respect to the production direction 5, a web of material 11 is unwound from a supply roll 13. The web of material 11 is conveyed by means of a transport device 15 along the production direction 5 successively through the preforming station 7 and the forming station 9. The web of material 11 includes a fiber-containing material, such as a paper material. The transport device 15 may include clamp chains that grip the web of material 11 from both lateral sides (right and left) with respect to the production direction 5, thereby conveying the web of material 11 along the production direction 5.

The preforming station 7 includes a preforming die upper part 17 and a preforming die lower part 19. The material web 11 is conveyed between the preforming die upper part 17 and the preforming die lower part 19. The preforming die upper part 17 and the preforming die lower part 19 are movable relative to each other with respect to a vertical direction toward each other into a closed position in order to deform the web of material 11 between each other. The preforming die upper part 17 may include a male forming part and the preforming die lower part 19 may include a corresponding female forming part.

FIG. 2 shows a schematic sectional view through the preforming die upper part 17 and the preforming die lower part 19 with the web of material 11 arranged therebetween. The preforming die upper part 17 has a forming profile on its lower side and the preforming die lower part 19 has a complementary forming profile on its upper side. When the preforming die upper part 17 and the preforming die lower part 19 are moved towards each other with respect to a vertical direction into a closed position, the web of material 11 between the preforming die upper part 17 and the preforming die lower part 19 is deformed according to the forming profiles.

In the illustrated embodiment, a plurality of bulges are defined by the forming profiles of the preforming die upper part 17 and the preforming die lower part 19, by means of which protrusions 25 are created in the web of material 11 during preforming of the web of material 11 in the preforming station 7. Both upward and downward bulges 25 are created in the web of material 11, thereby creating an undulating pattern, at least in a sectional view. In FIG. 2, a height and a depth of the bulges 25 are exaggerated for simplified illustration. In practice, a height and a depth of the bulges 25 may be significantly smaller relative to a length of the formed forming region of the web of material 11.

Preforming in the preforming station 7 prepares the web of material 11 for further forming in the forming station 9. By forming the bulges 25, the web of material 11 is pre-stretched to some extent in the processed forming area.

In the illustrated embodiment, bowl-shaped packaging depressions 27 are to be produced (see FIG. 3). When forming such packaging depressions 27, a deformation of the web of material 11 is highest in the portions that form the side walls 29 of the packaging depression 27 and in portions that form a transition region 31 between the side walls 29 of the packaging depression 27 and a bottom 33 of the packaging depression 27. In order to prevent the occurrence of high loads in these portions and thus possibly a tearing of the material web 11 during forming in the forming station 9, the web of material 11 is formed in corresponding portions during preforming in the preforming station 7 with an increased degree of deformation. This is shown in FIG. 2 by higher or deeper bulges 25 generated in the web of material 11 in the corresponding portions.

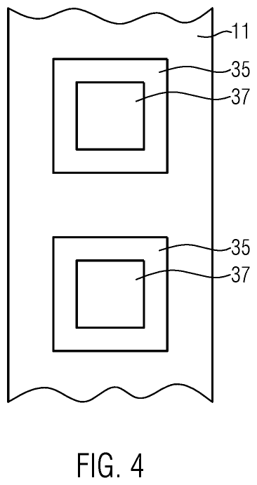

FIG. 4 shows the web of material 11 in plan view between the preforming station 7 and the forming station 9. A forming region formed in the preforming station 7 includes a portion 35 of higher deformation. This portion will later form the outer walls 29 and/or the transition region 31 between the outer walls 29 and the bottom region 33 of the packaging depression 27. The portion 35 of higher deformation encloses a portion 37 of lower deformation that will later form, for example, the bottom region 33 of the packaging depression 27.

The forming station 9 includes a forming die upper part 21 and a forming die lower part 23. The web of material 11 is conveyed between the forming die upper part 21 and the forming die lower part 23. The forming die upper part 21 and the forming die lower part 23 are movable relative to each other with respect to a vertical direction toward each other to a closed position, so as to deform the web of material 11 therebetween and to form the packaging depression 27 in the forming region preformed in the preforming station 7. The forming die upper part 21 may include a male forming part, and the forming die lower part 23 may include a corresponding female forming part. FIG. 3 shows a schematic sectional view of the forming die upper part 21 and the forming die lower part 23.

In the illustrated embodiment, a heating device 39 for heating the web of material 11 is provided upstream of the preforming station 7 with respect to the production direction 5 and between the preforming station 7 and the forming station 9, respectively. Heating the web of material 11 may facilitate forming the material web 11 in the preforming station 7 and in the forming station 9. Alternatively, only one of the illustrated heating devices 39 may be provided, or the heating devices 39 may both be omitted.

In the illustrated embodiment, a moistening station 41 is provided upstream of the preforming station 7 with respect to the direction of production 5 and between the preforming station 7 and the forming station 9, respectively. The moistening station stations 41 are configured to moisten the web of material 11, for example by spraying the web of material 11 with a liquid, in particular with water. Moistening the web of material 11 may facilitate forming of the web of material 11 in the preforming station 7 or in the forming station 9. Alternatively, only one of the two illustrated moistening stations 41 may be provided, or the moistening stations 41 may both be omitted.

The apparatus 1 including the preforming station 7 and the forming station 9 may be provided on its own. However, the apparatus 1 may also be provided, for example, as part of a packaging machine, in particular as part of a thermoforming packaging machine. For this purpose, for example, in the arrangement shown in FIG. 1 downstream of the forming station 9 with respect to the direction of production 5, an insertion section for inserting products to be packaged into the packaging depressions 27 may be provided. Downstream of the insertion section, a sealing station may be provided for sealing the packaging depressions 27. A cutting device may be provided so as to separate the packaging depressions 27 from the material web 11.

What is claimed is:

1. A method for manufacturing a packaging container, comprising:
conveying a web of material including a fiber-containing material through a preforming station and through a forming station;
in the preforming station, preforming a forming region of the web of material by cooperation of a preforming die upper part with a preforming die lower part, the forming region being deformed during the preforming between the preforming die upper part and the preforming die lower part; and
in the forming station, forming a packaging depression in the preformed forming region by cooperation of a forming die upper part with a forming die lower part, the preformed forming region being deformed between the forming die upper part and the forming die lower part during the forming.

2. The method according to claim 1, wherein the fiber-containing material is a material comprising natural fiber.

3. The method according to claim 1, wherein the fiber-containing material comprises a paper material.

4. The method according to claim 1, wherein a fiber content of the web of material is at least 70 percent by mass.

5. The method according to claim 1, wherein a fiber content of the web of material is at least 75 percent by mass.

6. The method according to claim 1, wherein a fiber content of the web of material is at least 80 percent by mass.

7. The method according to claim 1, wherein a fiber content of the web of material is at least 85 percent by mass.

8. The method according to claim 1, wherein a fiber content of the web of material is at least 90 percent by mass.

9. The method according to claim 1, wherein a fiber content of the web of material is at least 95 percent by mass.

10. The method according to claim 1, wherein a plurality of bulges of the web of material is produced in the forming region during the preforming.

11. The method according to claim 1, wherein the web of material is bulged in the forming region towards both two-dimensional sides of the web of material during the preforming.

12. The method according to claim 1, wherein an undulating pattern is formed in the forming region of the web of material during the preforming.

13. The method according to claim 1, wherein, during the preforming, a degree of deformation of the web of material is greatest in portions which, after the forming, form a transition region between one or more side walls of the packaging depression and a bottom of the packaging depression.

14. The method according to claim 1, wherein, during the preforming, a portion of lower deformation is formed in the forming region of the web of material, the portion of lower deformation being framed by a portion of higher deformation.

15. The method according to claim 1, wherein the forming region of the web of material is moistened and/or heated before at least one of the preforming and the forming.

16. An apparatus for manufacturing a packaging container, comprising:
a preforming station having a preforming die upper part and a preforming die lower part;
a forming station arranged downstream of the preforming station and having a forming die upper part and a forming die lower part; and
a transport device configured to convey a web of material through the preforming station and through the forming station;
wherein the preforming die upper part and the preforming die lower part are configured to be moved relative to each other for deforming a forming region of the web of material between each other to preform the forming region;
wherein the forming die upper part and the forming die lower part are configured to be moved relative to each other for deforming the preformed forming region of the web of material between each other to form a packaging depression; and
wherein the preforming die upper part and the preforming die lower part are configured to create a plurality of bulges in the forming region of the web of material during the preforming.

17. The apparatus according to claim 16, further comprising a heating device for heating the web of material, wherein the heating device is arranged upstream of the preforming station or is arranged between the preforming station and the forming station.

18. The apparatus according to claim 16, further comprising a moistening station for moistening the web of material, wherein the moistening station is arranged upstream of the preforming station or is arranged between the preforming station and the forming station.
